(19) United States
(12) Patent Application Publication
(10) Pub. No.: US 2016/0132642 A1
(43) Pub. Date: May 12, 2016

(54) DEVICE AND METHOD FOR MONITORING FOOD INTAKE

(71) Applicant: Raz Carmi, Haifa (IL)

(72) Inventor: Raz Carmi, Haifa (IL)

(21) Appl. No.: 14/534,276

(22) Filed: Nov. 6, 2014

(51) Int. Cl. G06F 19/00; G06F 3/01; H04N 5/14; H04N 7/18

(52) U.S. Cl. CPC G06F 19/322; H04N 7/183; G06F 3/017; H04N 5/144

(57) ABSTRACT

A device for monitoring food intake by a user to whom the device is attached includes at least one camera to acquire a series of images of at least a partial view of a manipulable limb of the user. A processor is configured to apply a probabilistic model to determine based on the series of images if a motion of the limb corresponds to at least one predetermined gesture that is indicative of taking a bite. A recorded sequence of events is updated when the motion is determined to correspond to a predetermined gesture. A signaling unit is operable by the processor to produce a signal that is sensible by the user, the signal being indicative of the updating of the sequence of events.

### FIELD OF THE INVENTION

The present invention relates to a device and method for monitoring food intake.

### BACKGROUND OF THE INVENTION

It is often desirable to monitor an amount of food that is eaten by a person. The motivation for doing so may be related to health, or may be economic. Such food intake monitoring may contribute to improving eating habits and regulating the amount of food that is consumed daily. The monitoring may contribute to a pattern of controlling body weight or size or to controlling a health condition that is affected by food consumption. The monitoring may assist in maintaining or attaining a physical condition in anticipation of an athletic or other activity, the monitoring may assist in planning or budgeting for food consumption.

### SUMMARY OF THE INVENTION

There is thus provided, in accordance with some embodiments of the present invention, a device for monitoring food intake by a user to whom the device is attached, the device including: at least one camera to acquire a series of images of at least a partial view of a manipulable limb of the user; a processor configured to apply a probabilistic model to determine based on the series of images if a motion of the limb corresponds to at least one predetermined gesture that is indicative of taking a bite, and to update a recorded sequence of events when the motion is determined to correspond to the at least one predetermined gesture; and a signaling unit that is operable by the processor to produce a signal that is sensible by the user, wherein the signal is indicative of the updating of the sequence of events.

Furthermore, in accordance with some embodiments of the present invention, the signaling unit is operable to produce a haptic signal.

Furthermore, in accordance with some embodiments of the present invention, the haptic signal includes a vibration or knocking.

Furthermore, in accordance with some embodiments of the present invention, the signaling unit is placed so as to contact the user's skin when the device is attached to the user.

Furthermore, in accordance with some embodiments of the present invention, the processor is further configured to adjust operation of the signaling unit in accordance with a confidence level that is determined by the application of the probabilistic model.

Furthermore, in accordance with some embodiments of the present invention, the device further includes a band for placement about the limb for attachment to the limb.

Furthermore, in accordance with some embodiments of the present invention, the at least one camera includes at least two cameras, such that the series of images includes images of different sides of the limb.

Furthermore, in accordance with some embodiments of the present invention, the device further includes an audio device or a display device.

Furthermore, in accordance with some embodiments of the present invention, the manipulable limb includes a finger or hand.

Furthermore, in accordance with some embodiments of the present invention, the processor is further configured to compare a counted number of bites with a recommended number of bites, or a rate of counting of bites with a recommended rate of taking bites.

Furthermore, in accordance with some embodiments of the present invention, the processor is further configured to operate the signaling unit to generate a signal in accordance with a result of the comparison.

Furthermore, in accordance with some embodiments of the present invention, the application of the probabilistic model includes: identifying a feature in the acquired series of images; comparing the identified feature with one or more gesture features that are retrieved from a database of gesture features; and calculating a value that is indicative of a degree of correspondence between the identified feature and the gesture feature.

There is further provided, in accordance with some embodiments of the present invention, a method for monitoring food intake by a user, the method including: acquiring using a camera that is attached to the user a series of images of a manipulable limb of the user; analyzing the acquired images, using a processor, to identify a motion of the limb; applying by the processor a probabilistic model to calculate a probability that the identified motion corresponds to at least one predetermined gesture that is indicative of taking a bite; using the probability by the processor to determine if the identified motion is indicative of taking a bite during a time segment; and when the identified motion is determined by the processor to be indicative of taking a bite, updating a sequence of events and generating a signal.

Furthermore, in accordance with some embodiments of the present invention, the limb includes a finger or hand.

Furthermore, in accordance with some embodiments of the present invention, the method further includes generating a reminder signal.

Furthermore, in accordance with some embodiments of the present invention, generating the signal includes operating a haptic signaling unit to generate a haptic signal.

Furthermore, in accordance with some embodiments of the present invention, generating the signal includes adjusting the generating of the signal in accordance with a confidence level that is determined by the applying of the probabilistic model.

Furthermore, in accordance with some embodiments of the present invention, adjusting the generating of the signal includes decreasing a reinforcement level when application of the probabilistic model indicates an increase in the confidence level.

Furthermore, in accordance with some embodiments of the present invention, the method further includes comparing the sequence of events with a recommended number of bites or with a recommended rate of taking bites, and generating a signal in accordance with a result of the comparison.

Furthermore, in accordance with some embodiments of the present invention, the acquired images include a partial view of the limb.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a device for monitoring intake of food, in accordance with an embodiment of the present invention.

FIG. 2 is a schematic illustration of a controller of a food intake monitor device, in accordance with an embodiment of the present invention.

FIG. 3 is a flowchart depicting a method of bite monitoring, in accordance with an embodiment of the present invention.

FIG. 4A is a flowchart depicting a method for determining a gesture probability, in accordance with an embodiment of the present invention.

FIG. 4B is a flowchart depicting a method for adjusting signal generation to encourage user compliance with monitoring of food intake, in accordance with an embodiment of the present invention.

FIG. 5A schematically illustrates acquiring an image of a hand in an idle state prior to performing a finger-lifting gesture.

FIG. 5B schematically illustrates acquiring an image of a hand in an indicating state in which the small finger is lifted.

FIG. 6A schematically illustrates an image that was acquired as illustrated in FIG. 5A.

FIG. 6B schematically illustrates an image that was acquired as illustrated in FIG. 5B.

FIG. 7A schematically illustrates acquiring an image of a hand holding a utensil in an idle state prior to performing a finger-extending gesture.

FIG. 7B schematically illustrates acquiring an image of a hand holding a utensil in an indicating state in which the small finger is extended.

FIG. 8A schematically illustrates an image that was acquired as illustrated in FIG. 7A.

FIG. 8B schematically illustrates an image that was acquired as illustrated in FIG. 7B.

FIG. 9A schematically illustrates acquiring an image of a hand in an idle state prior to performing a hand-motion gesture.

FIG. 9B schematically illustrates acquiring an image of a hand in an indicating state in which the hand is bent backward at the wrist.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

In accordance with an embodiment of the present invention, a food intake monitor device is configured to update an event sequence by detection of an intentional hand gesture by a user. The user may make the gesture each time a bite of food is taken or eaten by the user. The event sequence includes a sequence of time segments of equal or of variable length, each segment being characterized by whether or not a bite was taken in that time segment. As used herein, taking a bite of food or bite refers to an act of bringing a portion of food or beverage to the mouth, or to an act of swallowing a portion of beverage. The gesture may include a predetermined movement of a manipulable limb or limb extremity. For example, the manipulable limb or limb extremity may include one or more fingers of the hand, the palm or back of the hand, or of another part of the hand or other limb. In some cases, the manipulable limb may include the small finger, or another limb or limb extremity that may be moved during eating without interfering with movement that necessary for eating. For example, movement of the small finger may not interfere with manipulation of eating utensils such as silverware or cutlery, or of cups, glasses or other utensils. A gesture made with a limb extremity such as a small finger may be relatively unobtrusive and may not be noticeable by a casual observer. A gesture may be selected to be a motion of a limb that is not ordinarily part of the usual motions of the user when not gesturing. In some cases, gesture detection may be facilitated by use of one or more easily detectable markers, e.g., incorporated in a ring, bracelet, wristwatch, or glove, or attached to the user's skin.

Thus, the food intake monitor device may be operated to record an event sequence for bites of food that are eaten. The food intake monitor device may also be configured to analyze the event sequence to calculate a total count or a rate at which bites of food are eaten, or otherwise analyze the event sequence. The food intake monitor device is configured to generate a haptic or tactile signal or indication, or another type of signal or indication that is sensible by the user, when the gesture is detected. A signal or indication may also be generated when analysis of counted bites detects a situation that is to be brought (e.g., in accordance with predetermined rules or criteria) to the user's attention (e.g., when a reminder is indicated).

The food intake monitor device is configured to be mounted on or worn by a user. For example, the food intake monitor device may be mounted on, or incorporated into, a band or strap that may be worn around the user's wrist or arm. The food intake monitor device includes a video camera or other imager acquisition device that is aimed to acquire video images of the user's hand. For example, when the food intake monitor device is worn by the user, the camera of the food intake monitor device is aimed toward a part of the user's hand that is moved as part of a gesture to be counted.

The camera may be positioned such that images that include only a partial view of the user's hand are acquired. As used herein, a partial view of the user's hand refers to a view in which a part of the hand that is moved as part of the gesture is not imaged by the camera due to a blocking object in the foreground. The blocking object may include part of the user's wrist, or a part of the user's arm or hand that is located between the camera and the parts of the hand that move as part of the gesture. The partial view may include a partial view of the back of the hand, of the front side of the hand (that includes the palm of the hand), or a side of the hand.

The video images of the hand are analyzed to detect movement of part or all of the hand. The detected movement may be analyzed to determine if the detected hand movement corresponds to a predetermined hand gesture. For example, a calibration procedure may include acquiring calibration images of the hand of a particular user when that user is wearing the food intake monitor device. The images, or characterizing data that is derived by analysis of the calibration images, may be saved for later reference, for example, in analysis of image that are acquired when the user is eating and is making a gesture in order to indicate taking a bite.

A calibration procedure may be performed for an individual user, e.g., before first using food intake monitor device, or as repeated from time to time as required. The calibration procedure may include requesting the user to perform different hand gestures. An algorithm may be executed to methodically learn to recognize each hand gesture and to generate a gesture database. A training period (e.g., of several days) may be required to refine or optimize the accuracy of the gesture detection and bite event sequence determining process, and to enable the user to become accustomed to use of the device. The calibration procedure may also request the user to perform the gestures while holding and using various common utensils.

The analysis may include comparing characteristics of the images at the time of eating with characteristics of the calibration images. A statistical analysis may be applied to determine a likelihood that a hand motion that is detected in the images corresponds to the hand gesture as imaged in the calibration images. The likelihood (or a series of likelihoods related, e.g., to various aspects of the imaged motion) may conform to predetermined criteria (e.g., a threshold likelihood). When the likelihood conforms to the criteria, the detected movement may be interpreted as a hand gesture that indicates taking a bite of food.

When a hand gesture that indicates taking a bite of food is detected, a determined event sequence of bites may be updated by adding one event. The updating of the determined event sequence of bites may include redistributing, adding, or deleting one or more recorded events in previous periods of the event sequence. The food intake monitor device may then generate an indication that the determined event sequence is being updated. For example, the food intake monitor device may operate a haptic signaling element or unit to generate a haptic or tactile signal in the form of a vibration, knock, tap, or other haptic signal. Alternatively or in addition, a visible or audible signal may be generated.

Use of a voluntary gesture by the user to indicate taking a bite may be advantageous over devices that are configured to autonomously identify a hand motion or other motion that is assumed to be indicative of taking a bite. Such autonomous methods could be subject to inaccuracy as other motions may be very similar to eating-related motions.

Two or more different types of gestures may be defined to indicate different actions. The gestures may be distinguished from one another by a direction of motion, a speed or duration of a movement (e.g., lifting or extending a finger), or by the limb extremity that is moved. For example, the different actions may include different amounts or types of food that are eaten (e.g., based on the user's real time estimation or awareness of what and how much was eaten). One type of gesture may indicate cancelling or deleting a bite that was mistakenly reported. A type of gesture may indicate pausing or resumption of bite monitoring. A type of gesture may indicate an update of the determined event sequence to retroactively report a previously unreported bite (e.g., due to failure to report or to an undetected gesture).

Providing feedback to the user in the form of a haptic signal may be advantageous. Providing the haptic feedback may serve to remind the user, or condition the user, to perform the gesture when taking each bite. For example, the food intake monitor device may be operated in a reminder mode that produces a haptic signal that is designed to remind the user to continue to indicate bites by performing the gesture. When operated in an acknowledge mode, the feedback may indicate that a gesture was successfully identified. Different types of signals or feedback may be distinguished from one another, e.g., by different vibration patterns that are generated by a haptic signal generator. Overall, providing feedback may encourage user compliance with monitoring of food intake.

Providing of feedback may be automatically adjusted in accordance with accumulated experience. For example, a reminder signal may no longer be generated when a pattern of detected gestures is considered (e.g., as determined by comparison with predetermined criteria) to indicated that the user is faithfully gesturing to signal each bite. In this manner, haptic signaling may be automatically adjusted to limit or prevent excessive annoyance or intrusiveness.

Additional analysis may calculate total number or rate at which bites are counted (e.g., as a total number of bites per day, or number of bites per another unit of time), or another analysis result. One or more of the analysis results may be compared with one or more criteria. For example, the criteria may relate to a recommended maximum or minimum number of bites per meal, a recommended maximum or minimum bite rate, or another characteristic of the user's eating. Comparison with the criteria may indicate conformance or nonconformance of the user's eating or eating habits with recommended practices. The food intake monitor device may generate an indication that indicates to the user whether or not the user's eating conforms to recommended practice. In some cases, a comparison with the criteria may be interpreted to indicate whether or not the user is likely to be properly reporting each bite. In the event that underreporting or over-reporting is indicated, an indication may be generated that warns or urges the user to properly report the bites of food that are eaten.

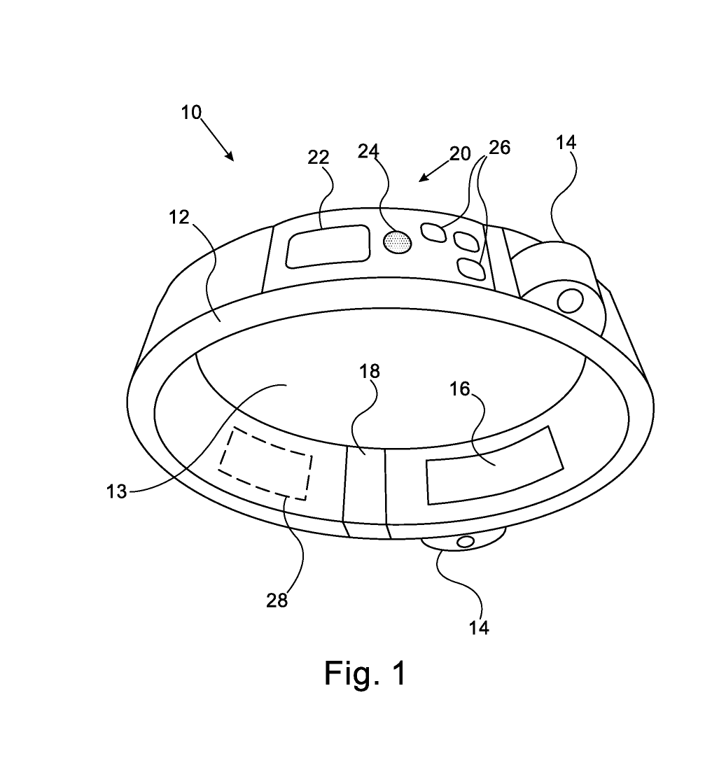

FIG. 1 schematically illustrates a device for monitoring intake of food, in accordance with an embodiment of the present invention.

Food intake monitor device 10 is configured to be worn on a body of a user. Band 12 is configured to fit around a limb of the user that is inserted into central opening 13. For example, band 12 may fit around a wrist, arm, or other limb of the user. Band 12 may be made of a flexible material (e.g., flexible plastic, leather, cloth, or other flexible material), or may include jointed segments of a rigid material or construction (e.g., metal, rigid plastic, or other rigid material).

Attachment mechanism 18 may be operated to separate or attach two parts of band 12, or to adjust a separation between the two parts of band 12. Attachment mechanism 18 may include one or more of a buckle, clip, pin, snap, hook-and-loop fastener (e.g., including Velcro® surfaces), sliding or telescoping element, or another mechanism. For example, attachment mechanism may be operated to detach one free end of band 12 from another, or to lengthen the perimeter of band 12, so as to enable insertion of a limb into central opening 13. Attachment mechanism 18 may be operated to attach one free end of band 12 to another, or to shorten the perimeter of band 12 so as to tighten band 12 about the limb so as to hold food intake monitor device 10 in place on the limb.

Food intake monitor device 10 includes one or more cameras 14. A camera 14 may include a video camera, or other imaging device that is capable of acquiring images at a sufficient rate to enable detection of a motion that corresponds to a gesture. Each camera 14 is configured, when food intake monitor device 10 is worn on an appropriate limb, to image a part of a limb (e.g., a limb extremity such as a hand or finger) that may be moved in the form of a gesture. When food intake monitor device 10 includes multiple cameras 14, each camera 14 may be configured to acquire images of a different side of a limb. For example, one camera 14 may be aimed at a back of a hand, while another camera 14 may be aimed at a front (palm side) of a hand.

Each camera 14 may be configured for detection of a gesture. For example, camera 14 may include imaging optics that are suitable for imaging all parts of the limb that performs the gesture with sufficient resolution to enable detecting of the gesture. For example, a field of view of the lens may be sufficient to image all parts of the limb that participate in the gesture and are not block from view. An aperture may be sufficiently small to enable sufficient depth of field when imaging the gesture. A detector of camera 14 may have sufficient range so as to image the gesture under varied lighting conditions (e.g., indoor, outdoor, different types of artificial lighting, shadows, or other conditions). A camera 14 may include an illumination lamp or infrared sensor to enable imaging under conditions of dim ambient lighting.

In order to avoid interference with the user's usual activities, a height of camera 14, or maximum thickness of components of food intake monitor device 10 may be limited. For example, the maximum thickness may be limited to 15 mm or less. When food intake monitor device 10 is worn on the user's wrist, a typical distance between camera 14 and a finger that performs a gesture may be less than 130 mm. Therefore, camera 14 may be positioned to acquire an image with only a partial view of a finger that is performing the gesture (with part of the view being blocked by the hand or other fingers). In some cases, e.g., to avoid clothing that may obscure a view of a gesture, camera 14 may be mounted on an extendible rod or post.

Food intake monitor device 10 includes a haptic signaling unit 16. For example, haptic signaling unit 16 may include a vibrator, a transducer, a knocking element, or other element capable of producing a mechanical or electrical stimulus that may be felt by a user's skin. Haptic signaling unit 16 is placed on an inner side of band 12 that faces central opening 13. Thus, when band 12 is closed about a limb that is inserted through central opening 13, haptic signaling unit 16 may be in contact with the skin of the limb. Thus, when haptic signaling unit 16 is operated to generate a haptic signal, the generated haptic signal may be detected by the user. For example, haptic signaling unit 16 may be operated to indicate that a determined event sequence of bites has been updated, or to indicate a warning. The warning may related to a detected eating pattern (e.g., eating too quickly or suspected underreporting of bites), to operation of food intake monitor device 10 (e.g., a detected or suspected malfunction or user error), or to other aspects of use or operation of food intake monitor device 10.

Food intake monitor device 10 may include one or more input/output devices 20. For example, input/output devices 20 may include one or more of a display device 22 or an audio device 24. A display device 22 may include one or more of a display screen (e.g., a liquid crystal display), an indicator lamp, or other type of device capable of producing a visible output. In some cases, display device 22 may include a touch screen so as to enable display device 22 to additionally function as an input device. Audio device 24 may include one or more of a speaker, buzzer, bell, clicker, or other device that may be operated to emit an audible signal or other sound. One or more components of display device 22 or of audio device 24 may be located on a device that is external to food intake monitor device 10. For example, the component of display device 22 or audio device 24 may be located on a computer or smartphone with which food intake monitor device 10 is configured to communicate.

One or more of display device 22 or audio device 24 may be operated to produce an alert or to provide information to a user of food intake monitor device 10. Display device 22 or audio device 24 may be operated concurrently with operation of haptic signaling unit 16. Concurrent operation of display device 22 or audio device 24 may enable provided supplementary information that is not conveyed by haptic signaling unit 16. For example, display device 22 or audio device 24 may be operated to provide more detailed information that relates to a haptic signal that is concurrently generated by haptic signaling unit 16 (e.g., a bite total count or rate, a nature of an error or failure, or other signals or information). Display device 22 or audio device 24 may be operated to display information independently of display device 22 or audio device 24. For example, display device 22 or audio device 24 may be operated to display a current time, a name or other information regarding a user, or other information.

Input/output devices 20 may include one or more user-operable input devices 26. For example, an input device 26 may include a pushbutton or other touch-operated device, a knob, wheel, or dial, a microphone, a pointing device, a touch screen (e.g., incorporated into display device 22), or other user-operable device. One or more components of input device 26 may be located on a device that is external to food intake monitor device 10. For example, the component of input device 26 may be located on a computer or smartphone with which food intake monitor device 10 is configured to communicate.

Input devices 26 may be operated to input instructions to, or to control or operate food intake monitor device 10. For example, an input device 26 may be operate to turn on or to turn off food intake monitor device 10, to reset a bite event sequence, to input information related to the bite event sequence (e.g., a limit to a total number of bites or bite rate beyond which the user is to be alerted, a type of food or meal, or other information), to correct a bite event sequence (e.g., delete an extra event from the event sequence due to accidentally gesturing or an erroneous detection of a gesture, or add an event to the event sequence after the user did not gesture), select or adjust characteristics of a signal that is to be produced by haptic signaling unit 16, by display device 22, or by audio device 24, or other operation of food intake monitor device 10.

Food intake monitor device 10 includes a controller unit 28. Controller unit 28 is configured to control operation of food intake monitor device 10.

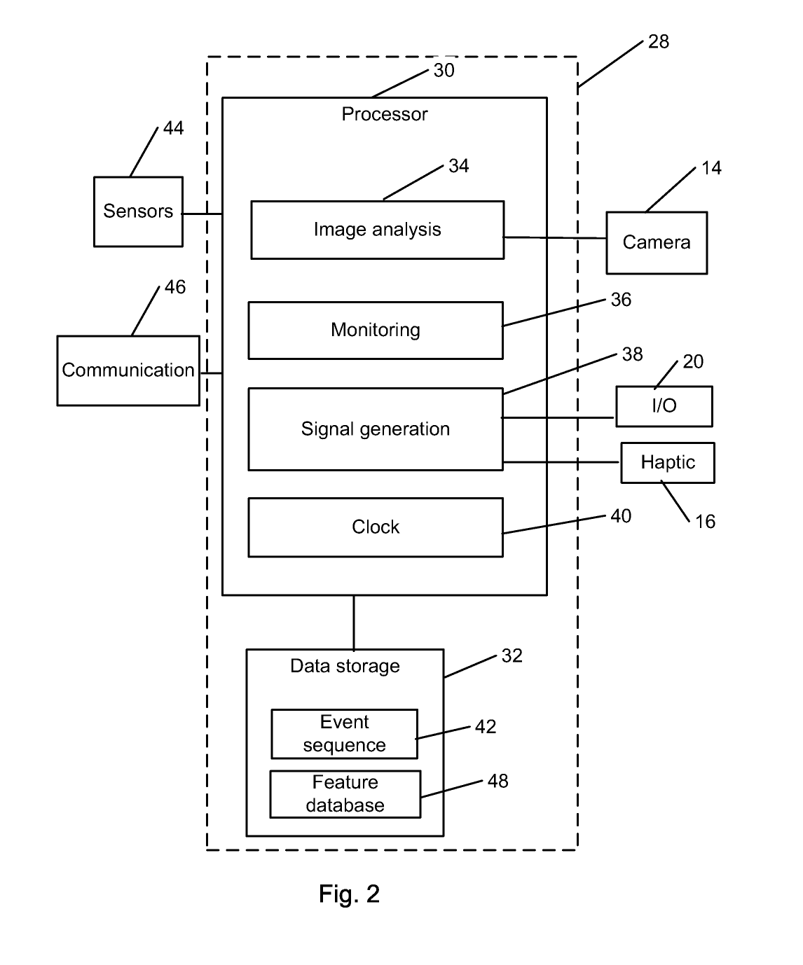

FIG. 2 is a schematic illustration of a controller of a food intake monitor device, in accordance with an embodiment of the present invention.

Controller unit 28 may include a processor 30. Processor 30 may be configured to operate in accordance with programmed instructions. Some or all of the functionality of processor 30 may be included in a remote or separate device. For example, controller unit 28 may include a communications capability that enables communication (e.g., via a wireless connection or network) with a separate device that includes a processor. For example, controller unit 28 may be configured to communicate with a remote device in the form of a smartphone or portable computer, e.g., via a communications link 46. In this case, data may be communicated to the separate device for processing by a processing unit of the remote device.

Controller unit 28 includes a data storage device 32. Data storage device 32 may include a memory unit in the form of one or more volatile or nonvolatile memory devices. Data storage device 32 may include one or more fixed or removable nonvolatile data storage devices. For example, data storage device 32 may include a computer readable medium for storing program instructions for operation of processor 30. In such cases some capability of data storage device 32 may be a storage device of a remote server storing programmed instructions in the form of an installation package or packages that can be downloaded and installed for execution by processor 30, e.g., via communications link 46. Data storage device 32 may be utilized to store data or parameters for use by processor 30 during operation, or results of operation of processor 30. For example, data storage device 32 may be utilized to store an event sequence 42 that is produced by operation of processor 30.

Processor 30 may be configured to execute image analysis module 34. Execution of image analysis module 34 may process images that are acquired by camera 14 to detect motion of one or more imaged objects, such as a limb extremity. The processing may include determining an orientation of an acquired image, e.g., with reference to a tilt sensor of sensors 44. The processing may include inference of a motion of a limb extremity from a partial view of the limb extremity (with part of the view being blocked by other parts of the limb). Execution of image analysis module 34 may analyze any detected motion to determine whether the detected motion corresponds to a predetermined gesture.

Controller unit 28 may operate in a calibration mode. When the controller unit 28 is operating in a calibration mode, execution of image analysis module 34 may analyze one or more sequences of calibration images. Each sequence may be known to include images of a limb extremity moving to form a gesture. Analysis of the calibration images may enable identification of one or more gesture features, characteristics, or parameters of the imaged motion. For example, a gesture feature may include a position, motion, or both of a limb extremity relative to other parts of the limb as imaged by a camera of the food intake monitor device. The identified gesture features may be stored in feature database 48 on data storage device 32. Alternatively or in addition to calibration on an individual user, some or all of the gesture features that are stored in feature database 48 may be determined otherwise, e.g., via previous measurements on one or more gesturing people, on the basis of calculations or simulations, from published or privately communicated literature, or otherwise. Some or all of the stored gesture features may include default gesture features that represent a gesture made by a typical or average user. Some or all of the stored gesture features may include default gestures features that represent gestures made by several types of users, from which a type that is closest to a current user may be selected. The gesture features that are stored in feature database 48 may be applied in subsequent execution of image analysis module 34 to analyze subsequently acquired images to identify a characterized gesture. The gesture features may be indexed in a manner that enables efficient retrieval of a particular type of gesture feature from the database.

Execution of image analysis module 34 may identify one or more image features in each image as it is acquired. A probabilistic model may be applied to determine a probability or likelihood as to whether an identified feature corresponds to a gesture. The identified image features may be compared with the stored gesture features in feature database 48. The comparison may yield one or more scores or values that are each indicative of a degree of similarity between the identified image feature and one of the stored gesture features. Execution of image analysis module 34 may determine at each time point in real time (e.g., after analysis of each image or after another time interval during which the limb extremity is expected to move a distance that is much smaller than the distance moved when performing a gesture), on the basis of the comparison results and in accordance with classification logic, a probability that the imaged limb extremity is either idle (e.g., not performing a gesture) or performing a gesture. A probability may be determined with regard to each gesture whose features are included in feature database 48, or with regard to a subset of the gestures (e.g., as determined by comparison with selection criteria). Instructions or parameters for use in identifying a predetermined gesture may be refined on the basis of user feedback or otherwise.

Processor 30 may be configured to execute monitoring module 36. Execution of monitoring module 36 may update event sequence 42 when a predetermined gesture is identified by image analysis module 34. For example, event sequence 42 may be updated by adding one event when a probability of detection of a predetermined gesture exceeds a threshold value. A decision to update event sequence 42 may depend on meeting one or more additional criteria. For example, if an interval between identified gestures is shorter than a minimum interval (e.g., less than 1 second or another predetermined interval, or is significantly shorter than previously recorded bite intervals for a particular user), it may be determined that one of the identified gestures is not indicative of a bite.

In some cases, event sequence 42 may be adjusted retroactively on the basis of analysis of subsequently analyzed images. For example, if an identified feature is assigned an indeterminate probability (between a probability that indicates a gesture with a high degree of certainty and one that indicates no gesture with a high degree of certainty), but a repetition rate of that identified feature is similar to a typical bite frequency during eating, then the identified feature may be retroactively determined to indicate bites and event sequence 42 may be updated accordingly. A probability may be adjusted on the basis of time of day (e.g., a usual meal time), a determined location (e.g., whether or not in a lunchroom or restaurant), or other information.

In some cases, a decision whether or not to update event sequence 42 may depend on a state of execution of signal generation module 38. For example, if a reminder signal is being generated, an identified hand motion may be more likely to be identified with an intentional gesture than when no reminder signal is being generated, or when the reminder signal is of low intensity or frequency. An identified hand motion may be more likely to be identified with an intentional gesture when it immediately follows a reminder signal. If a gesture is detected closely following a detected motion that was not identified with a gesture due to low probability such that no acknowledge signal was generated for the first motion, the first motion may be more likely to be identified as a gesture than the second (the second motion being assumed to repeat the first motion).

Execution of monitoring module 36 may include associating some or all detections of a predetermined gesture with a time, e.g., as generated by clock function 40, or with other state information. Some or all of the times may be stored on data storage device 32. Execution of monitoring module 36 may include calculation of a bite rate.

Execution of monitoring module 36 may include comparing a number of bites, a number of bites during a predetermined period of time (e.g., day, week, or other period), a rate of taking bites or time between bites, or another result of monitoring, with one or more ranges or thresholds. For example, the ranges may indicate a desired manner of eating, or an undesirable manner of eating. Ranges may be defined in accordance with various types of health-related or other (e.g., related to economic or esthetic concerns, etiquette, or other) considerations. Execution of monitoring module 36 may include periodically requesting the user to input data (e.g., by operating input/output devices 20) that may be utilized in calculating a range or threshold. For example, the user may be requested to enter the user's weight, height, age, gender, information related to an activity level, sleeping habits, or other information that may be utilized in setting a desired range or threshold.

Execution of monitoring module 36 may include communicating a result of execution of monitoring module 36 to one or more external devices, such as a computer, smartphone, smart watch, or other external device, e.g., via communications link 46. The communications link 46 may be wired or wireless, and may include a network (e.g., a mobile telephone network or the Internet). Communications link 46 may include communicating with a remote server, e.g., of a food or health monitoring service, or sending an email or Short Mail Service (SMS) message.

Execution of monitoring module 36 may include determining if a signal is to be generated, e.g., as a reminder to gesture when taking a bite, or when a monitored quantity deviates from a predetermined range.

Processor 30 may be configured to execute signal generation module 38. Execution of signal generation module 38 may include controlling one or more of haptic signaling unit 16 or input/output devices 20 to generate a haptic, visible, or audible signal. Properties of the generated signal, and a choice of a device to be controlled to generate the signal, may be selected by a user, e.g., by operating input/output devices 20. Execution of signal generation module 38 may include generating a signal when a predetermined gesture is detected by execution of image analysis module 34. Execution of signal generation module 38 may include generating a signal when execution of monitoring module 36 indicates that a user is to be alerted. Characteristics (e.g., strength or duration) of a signal that is generated by execution of signal generation module 38 may be adjusted to avoid unnecessary obtrusiveness or annoyance to the user. The characteristics may be adjusted in accordance to a level of reinforcement that is to be provided at a particular time or phase.

In some cases, a user may operate a control to temporarily or permanently disable generation of a signal. In some cases, a user may operate a control to indicate that a gesture was incorrectly identified, and that event sequence 42 is to be adjusted or decremented. The indication of incorrect identification may be utilized by processor 30 to refine gesture detection during execution of image analysis module 34.

For example, execution of signal generation module 38 may operate haptic signaling unit 16 to generate a reminder signal. The user may, as a result of feeling the reminder signal, be reminded to perform a predetermined gesture when taking a bite. For example, a reminder signal may include a 1.5 second haptic signal every 20 seconds, or another pattern or type of signal. A reminder signal may be reduced in intensity or frequency when it is determined that the user does not require reminding (e.g., after the user has performed the gesture a predetermined number of times or a predetermined rate. An acknowledge signal may be generated to indicate that a gesture that was performed by the user has been successfully detected. For example, an acknowledge signal may include a single 1 second haptic signal, or another signal. An alert signal may be generated to notify the user of a deviation from a recommended or desired eating pattern, habit, or restriction. For example, an alert signal may include a 0.5 second haptic signal every 5 seconds for as long as the situation that triggered the alert continues, or another signal. In some cases, a haptic signal may be accompanied by a preceding, concurrent, or following visible or audible signal.

Processor 30 may receive signals from one or more sensors 44. Part or all of sensors, may be incorporated into or permanently connected to the food intake monitor device, or may be external to the food intake monitor device. For example, processor 30 may be configured to communicate with one or more external sensors 44, e.g., via communications link 46. Communications link 46 may include a socket, plug, or cable that enables a wired connection between processor 30 and an external sensor 44. Communications link 46 may include a wireless connection between processor 30 and an external sensor 44.

For example, sensors 44 may include one or more inertial or motion sensors (e.g., accelerometer, tilt sensor, rotation sensor), light sensors, or other sensors. The received signals may be utilized in execution of image analysis module 34 (e.g., to assist in interpretation of acquired images), of signal generation module 38 (e.g., to assist in automatically determining a desired strength or level of a generated signal), or otherwise by processor 30. Sensors 44 may include one or more sensors that are configured to sense one or more aspects of a physical state of the user. For example, such sensors 44 may include a weighing scale, a blood pressure monitor, a pulse detector, a pedometer, a blood sugar monitor, a sleep monitor, or other type of sensor or monitor. Sensors 44 may include a Global Positioning System (GPS) receiver, or other navigation sensors, for determining a location of the food intake monitor device.

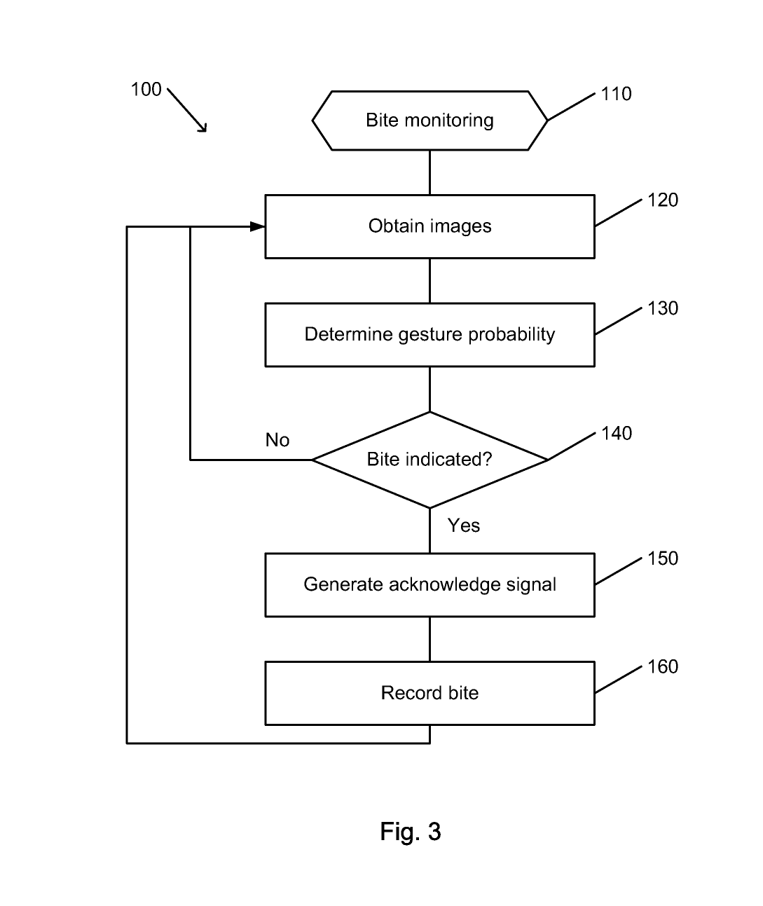

FIG. 3 is a flowchart depicting a method of bite monitoring, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Bite monitoring method 100 may be executed, e.g., by a processor of a food intake monitor device, such as of controller 28 of food intake monitor device 10 (FIG. 1).

Bite monitoring method 100 may be executed when a bite monitoring mode has been initiated (block 110). For example, a bite monitoring mode may be initiated by operation of a user-operable control, or automatically (e.g., when the time of day corresponds to a typical mealtime for the user or for a population of users). A user may initiate a bite monitoring mode a short time, e.g., minutes or seconds, before starting to eat.

When a bite monitoring mode has been initiated, reminder signals may be generated. In some cases, initiating a bite monitoring mode may include resetting one or more counters, or deleting some or all previously stored data that relates to bite monitoring.

A series of images are obtained (block 120). The images may be acquired via operation of a video camera or other imaging device. The camera may be oriented such that the camera's field of view includes a hand or other limb extremity. The acquired images may include a partial view of the hand.

The images may be analyzed to calculate or otherwise determine a probability or likelihood that the acquired images include a predefined gesture (block 130). A probabilistic model may be applied to determine a probability or likelihood as to whether a feature that is identified in the images corresponds to a gesture. The analysis may occur in real time as each image is obtained. The gesture may include a particular movement of the imaged hand or of one or more fingers of the imaged hand, or another motion of a limb or of limb extremities. The user is expected to perform the gesture each time a bite is eaten, and not at any other time.

In some cases, acquired images may be deleted or discarded when analysis is complete. Alternatively or in addition, image data may be saved for later processing either within the food intake monitor device, or externally, e.g., on a remote device.

The resulting gesture probabilities, as well as other information, may be analyzed to determine if a bite was indicated (block 140). If it is determined that no bite is indicated, image acquisition analysis continues (returning to block 120).

If it is determined that a bite is indicated, an acknowledge signal is generated (block 150). Typically, the generated acknowledge signal includes a haptic signal, so that the acknowledgment is discrete and noticeable only by the user. Since the haptic signal is not discernable by others in the vicinity, the haptic signal is unlikely to disturb others or cause embarrassment to the user. In some cases, e.g., when so indicated by the user by operation of a user-operable control (e.g., when the user is alone or finds the haptic signal to be annoying or disturbing), the haptic signal may be accompanied by, or replaced with, a visible or audible signal.

The bite may be recorded (block 160). For example, an event sequence of bites may be updated. In addition, a time of the bite may be recorded, as well as any other bite-related data that may be considered to be relevant. The updated bite data may be stored. The updated bite data may be analyzed, e.g., by comparing an eating pattern that is indicated by the analysis with a recommended eating pattern. Some operations of the analysis may be executed continuously, some may be executed each time (or each several times that) the data is updated, and some may be executed at predetermined intervals or in response to predetermined events.

The process of obtaining and analyzing images continues (repeating blocks 120 to 160), e.g., as long as the food intake monitor device is operating in a bite monitoring mode. As a result, an event sequence of recorded bites may be constructed. In the event sequence, periods of time (e.g., equal time segments, e.g., of 1 second length or less, or of another length) may be classified as including a bite, as not including a bite, or including different types of bites. When the time segments are short (e.g., 0.1 second) several successive time frames may include a bite, or several successive time frames may not include a bite.

For example, a bite monitoring mode may be terminated by operation by a user of a user-operable control or by performing a predetermined gesture, e.g., when finished eating. A bite monitoring mode may be terminated automatically, e.g., after a predetermined time interval (e.g., after starting or after the last recorded bite), or in response to a predetermined event.

As a result of analysis of the bite data, it may be determined that an alert signal is to be generated. In some cases, the bite data, or a result of analysis of the bite data, may be transmitted to a remote device. For example, the user may review the results on the remote device, on a device that is connected to the food intake monitor device (e.g., via an appropriate cable), or on the food intake monitor device. The reviewed results may include or incorporate results from previous monitoring.

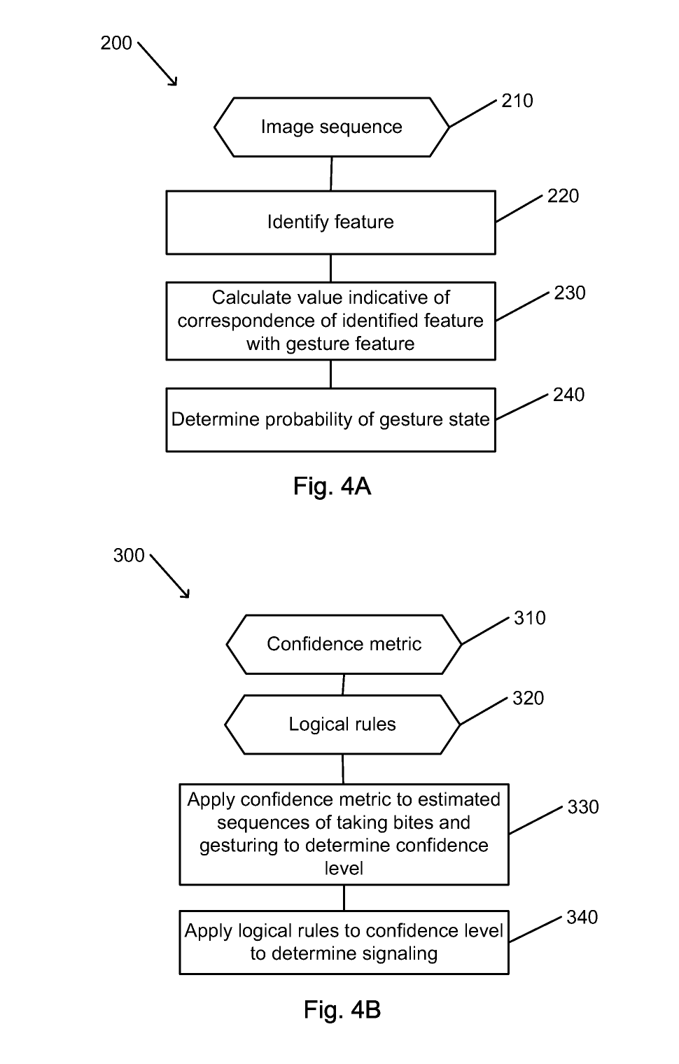

FIG. 4A is a flowchart depicting a method for determining a gesture probability, in accordance with an embodiment of the present invention. Gesture probability determination method 200 illustrates details of the operation indicated by block 130 of bite monitoring method 100 (FIG. 3). Gesture probability determination method 200 may be executed real-time and continuously during bite monitoring. For example, gesture probability determination method 200 may be performed at fixed intervals, e.g., every second, every 100 milliseconds, or at another interval (e.g., based on a frame rate of a camera or on a typical rate of movement of a limb when performing a gesture).

Gesture probability determination method 200 is performed on a sequence of images, e.g., video images or frames that are acquired by a camera of the food intake monitor device (block 210). For example, each of the images may include an image of a partially viewed hand or other limb or limb extremity that may be manipulated in the form of a gesture.

One or more features in the images may be identified (block 220). For example, an identified feature may include an identified movement or change in pixel values in one part of the image relative to another part of the image. For example, a change in color of pixels relative to a background, or a change in shape of a colored region, may be identified. A feature may be identified by identifying characteristics of a single image, e.g., corresponding to a single time segment, or may be identified by comparing at least two images in a temporal sequence of images to include temporal characteristics.

For example, an identified feature may be based on a change in shape of a contour of a partially-viewed limb, such as a hand, e.g., as hand, as captured in the acquired two-dimensional image. The contour may be expressed as spatial frequencies (e.g., based on Fourier analysis), wavelets, or curvatures. For example, a contour of a hand image may be interpreted to yield a number and position of fingers that are visible in a view of the hand. The feature may be identified based on a time rate and a magnitude of a change in the shape imaged contour, or a length of time required for the contour to change and approximately resume its original shape. The feature may be identified based on change in a relative area of a region of the acquired images that includes an image of the hand or other limb. The region may be identified based on, for example, pixel color (e.g., if the color of the user's skin has been measured, e.g., during calibration), intensity, or other characteristics. An identified feature may be based on one or more techniques for image feature extraction and tracking over time, such as speeded up robust features (SURF), scale-invariant feature transform (SIFT), or the Kanade-Lucas-Tomasi (KLT) feature tracker technique.

A value that is indicative of a correspondence between an identified feature and a feature of a predefined gesture may be calculated (block 230). For example, the identified feature may be compared with one or more predefined gesture features that are retrieved from a database of gesture features. The database may be indexed so as to facilitate retrieval of those gesture features that have at least one common characteristic (e.g., increase or decrease of colored region, or other feature characteristic) with the identified feature. The gesture features may have been extracted during analysis of images that were acquired during a calibration. During the course of the calibration, the user may have performed one or more gestures. Alternatively or in addition, the gesture features may have been (at least initially) defined by analysis or simulation of gestures as performed by a representative user. The comparison may include calculation of a value that is indicative of a degree of similarity between the identified feature and each predefined gesture feature (or each of a selected subset of all gesture features in a database).

A probability of a gesture state may be calculated (block 240). For example, classification logic may be applied to determine a likelihood that a series of identified features, each corresponding to a gesture feature to a different degree, corresponds to a gesture.

One or more pattern recognition, machine learning, or other techniques may be applied to determine a correspondence between an identified feature and a feature of a predetermined gesture, or to calculate a probability of the gesture state. For example, a k-nearest-neighbors algorithm may be applied to classify features based on finding the nearest training examples within a feature space, K-means clustering may be applied to statistically classify similar groups in a multi-feature space. A supervised learning model, such a support vector machine, may be applied.

For example, two gesture states may be defined: an idle state in which no predefined gesture is being made by the user (or a predefined non-indicating gesture is being made), and an indicating state in which the user is making a gesture that indicates a bite is being taken. In some cases, an additional indefinite or equivocal state may be defined. For example, an equivocal state may be related to a situation when the user suddenly performs other activities while eating that obscure a view or a limb, such as using a napkin. A probabilistic model may treat such a situation differently than a situation where the probabilities of the idle state and the indicating state are close to one another (e.g., close to 50%). This latter situation may be interpreted as a transition between the two gesture states.

A probability is assigned to each state. The probability may indicate the likelihood that the identified features are indicative of that state. Two or more different indicating states may be defined corresponding to different types of gestures or actions. For example, the different gestures may indicate different amounts or types of food that are eaten.

A probabilistic model for determining a bite sequence may be based on mathematical techniques, such as a dynamic hidden Markov model, a dynamic Bayesian network, a deep belief network model, or another technique may be applied to improve or ensure accuracy of bite monitoring. The result of interest of bite monitoring may include a sequence of time frames, where each time frame is classified in one of two or more primary states according to whether or not a bite was eaten during that frame. The state type may also be an indicative of more than one type of bite. The length of each time frame may be predetermined (e.g., as one second, or another length). The true state, whether or not a significant bite was actually taken, is considered to be a hidden or latent state for the purpose of the model, since the food intake monitor device does not directly and unambiguously detect when food is eaten. Similarly, the actual state of hand (or other limb) motions, e.g., whether or not the user intended to indicate a bite by the motion, is also considered for the purpose of the model to be a hidden state since it is also not unambiguously detected. The results of gesture image acquisition and analysis may be classified as an idle, equivocal, or a type of indicating state. These observations are not hidden states.

The model includes the relation probabilities between the different states. A set of transition probabilities T relates the primary hidden states of the time frames. A probability value (between zero and one) relates a state of each time frame to a possible state of the next time-frame (same or opposite). Transition probabilities between non-successive time frames may be included. Each actual performed hand gesture hidden state (non-indicating, indicating, or type of indicating state) may be related to the primary hidden time frame states (bite taken or not taken, or a type of taken bite) by a set of modeled emission or output probabilities E1. Each probability of the set E1, having a value between zero and one, represents a correlation between one of the actual hand gesture hidden states and one of the primary hidden states. Each observed state (idle, equivocal, indicating, or type of indicating) resulting from hand gesture image analysis is related to each of the actual hand gesture hidden states by one of a set of modeled emission probabilities E2, with a value between zero and one.

A model solver algorithm may be executed to find the most probable sequence of the user's actual actions that results in the observed hand gesture image analysis results, based on probabilities T, E1, and E2. The probabilities T, E1 and E2 may dynamically vary in time. The model solver algorithm may utilize one or more known mathematical techniques for expectation maximization or multi-parameter global maximization. For example, a genetic algorithm, or another type of evolutionary algorithm, may be applied to efficiently solve such a model. The results of execution of the model solver algorithm may be stored and accumulated over time in the form of a usable database.

Reinforcement by haptic or other signal generation may affect probabilities E1 of the model. The reinforcement level due to signal generation may be calculated dynamically with time, since signal generation is dynamically adjustable. For example, when signal generation is rapid and intense, the reinforcement level may be considered to be high. Thus, the user may be expected to more accurately indicate each bite, thus affecting probabilities E1.

A dynamic eating pattern model may be calculated continuously, based in part on the accumulative information in the database. The dynamic eating-pattern model affects transition probabilities T. The probabilities E2, relating actual and observed gesturing, may be automatically adjusted in accordance with conditions, such as low ambient light intensity which could reduce the image acquisition accuracy, automatic detection of partial camera obstruction, or automatic detection of a non-optimized position of the camera on the user's limb. Initial values of the sets of probabilities T, E1 and E2 may be determined during a training procedure of the model that uses predetermined reference eating monitoring sequences.

Signal generation may be configured to interact with the probabilistic model so as to encourage user compliance with the monitoring of food intake.

FIG. 4B is a flowchart depicting a method for adjusting signal generation to encourage user compliance with monitoring of food intake, in accordance with an embodiment of the present invention. Signal generation adjustment method 300 illustrates details of the operation indicated by block 150 of bite monitoring method 100 (FIG. 3). Signal generation adjustment method 300 may be executed in real-time and continuously during bite monitoring. For example, Signal generation adjustment method 300 may be performed at fixed intervals, e.g., every second, every 100 milliseconds, or at another interval (e.g., based on a frame rate of a camera or on a typical rate of movement of a limb when performing a gesture).

A confidence metric may have been determined, e.g., during a preparation phase (block 310). The confidence metric may be applied to indicate a confidence level of the correspondence of gesture detection with respect to actual bites. The confidence level may estimate the likelihood that the user is reliably indicating the bites that are actually taken.

A set of logical rules may have been generated, e.g., during a preparation phase (block 320). The logical rules may assign feedback reinforcement levels to possible combinations of haptic signaling parameters and patterns. Since many different combinations of signaling patterns are possible, assigning a single reinforcement level scale may improve control of the eating monitoring probabilistic model. For example, the determined feedback reinforcement level may be a function of the average values within a time window of the signal frequency, signal time span, signal repetition rate, or signal intensity.

The confidence metric may be applied to concurrent sets of data, e.g., based on time windows (block 330). A first type of data may correspond to an estimated sequence of the user's actual taking of bites (relating to estimation of the primary hidden state sequence in the probabilistic model). The second type of data may correspond to an estimated sequence of the performed hand gestures (relating to estimation of the second hidden state sequence in the probabilistic model). The two data sets may be extracted from a dynamic (e.g., moving in time) time window with a predefined length. In this way the two patterns may be analyzed dynamically, including any temporal changes. Optionally, the feedback optimization process may also utilize the modeled emission probabilities E1.

Application of the confidence metric to the first and second time-window input data sets may determine the confidence level corresponding to the gestures that are performed by the user. For example, the confidence metric can be a function of the mutual similarity between the two state sequences.

The logical rules may be applied to the confidence level to determine a desired feedback reinforcement level, and thus to determine a pattern of signaling (block 340). The feedback reinforcement level may be updated. For example, when the confidence level increases (e.g., indicative that the user is reliably and clearly gesturing to signal each bite that is taken), a feedback reinforcement level (e.g., a rate, frequency, or intensity of signaling) may be decreased, or vice versa. The feedback reinforcement level may be updated based on the confidence level and on the last feedback reinforcement level value (i.e. in a differential manner). The operation parameters of the feedback signaling may be updated based on the updated feedback reinforcement level.

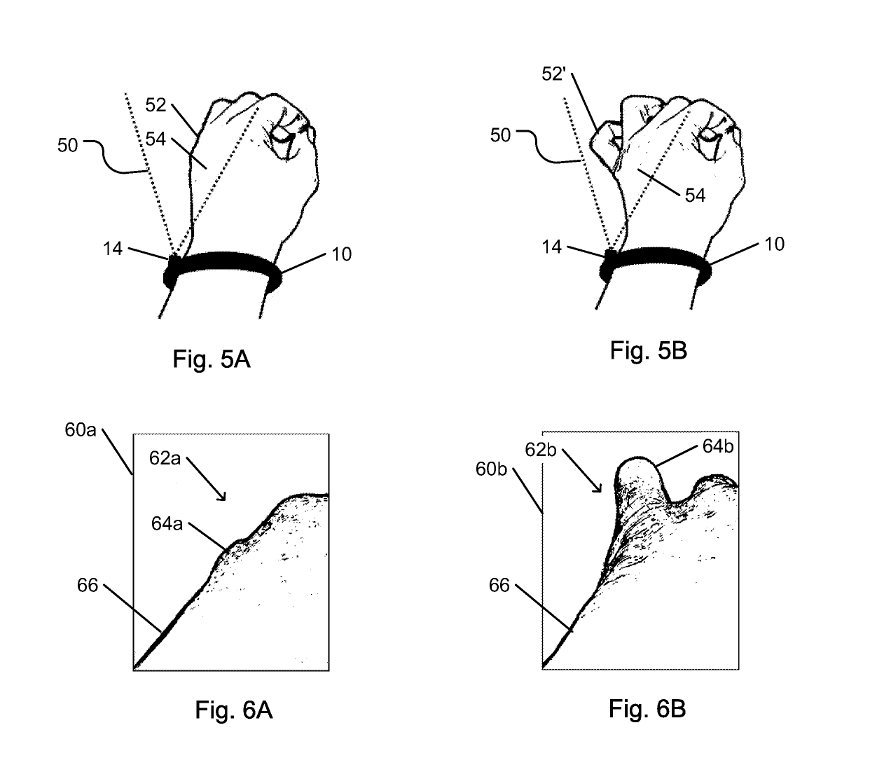

FIG. 5A schematically illustrates acquiring an image of a hand in an idle state prior to performing a finger-lifting gesture. FIG. 6A schematically illustrates an image that was acquired as illustrated in FIG. 5A.

Camera 14 of food intake monitor device 10 is aimed such that field of view 50 of camera 14 covers back-of-hand region 54, with folded small finger 52. Acquired image 60a shows hand partial view 62a with small finger image 64a not extending noticeably beyond hand contour image 66.

FIG. 5B schematically illustrates acquiring an image of a hand in an indicating state in which the small finger is lifted. FIG. 6B schematically illustrates an image that was acquired as illustrated in FIG. 5B.

Lifted small finger 52′ is imaged by camera 14. In acquired image 60b, hand partial view 62b includes lifted small finger image 64b as noticeably extending outward from hand contour image 66. In some cases, a gesture of lifting the small finger and folding the finger may be expected to take approximately one second. The gesture as shown may be performed by an empty hand of the user (e.g., a hand that is not used for eating), when holding a glass or cup, or under other circumstances. The gesture as shown may be also performed by a hand that is used for eating, when holding a utensil or food, or under other circumstances.

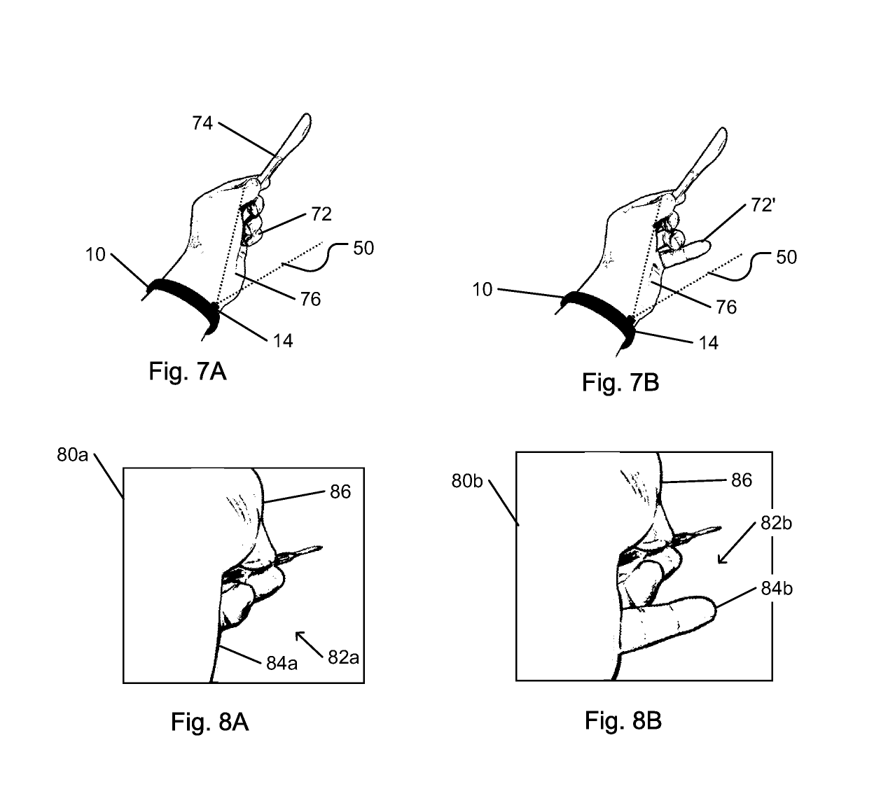

FIG. 7A schematically illustrates acquiring an image of a hand holding a utensil in an idle state prior to performing a finger-extending gesture. FIG. 8A schematically illustrates an image that was acquired as illustrated in FIG. 7A.

Camera 14 of food intake monitor device 10 is aimed such that field of view 50 of camera 14 covers palm region 76, with folded small finger 72. Acquired image 80a shows hand partial view 82a with small finger image 84a not extending noticeably beyond hand contour image 86.

FIG. 7B schematically illustrates acquiring an image of a hand holding a utensil in an indicating state in which the small finger is extended. FIG. 8B schematically illustrates an image that was acquired as illustrated in FIG. 7B.

Extended small finger 72′ is imaged by camera 14. In acquired image 80b, hand partial view 82b includes extended small finger image 84b as noticeably extending outward from hand contour image 86. The gesture of extending and folding folded small finger 72 may be performed conveniently when holding a utensil such as a knife, fork, or spoon without interfering with manipulation of the utensil. The gesture as shown may be also performed by an empty hand of the user (e.g., a hand that is not used for eating).

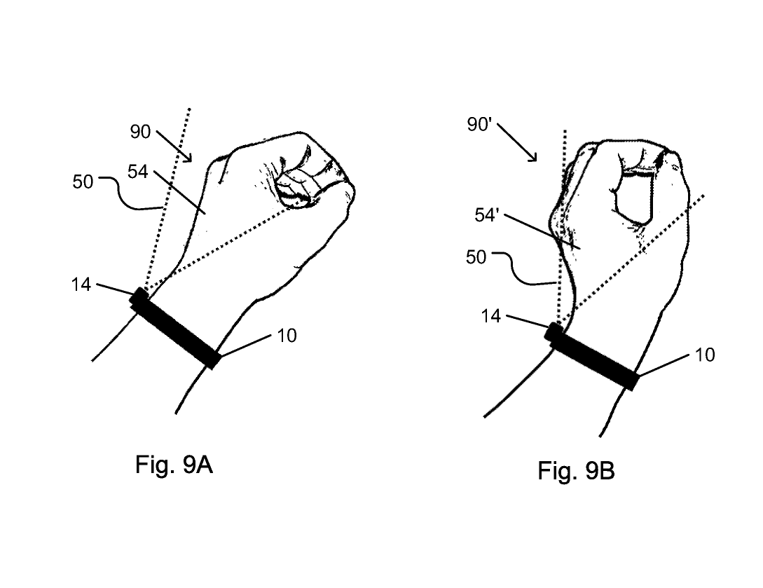

FIG. 9A schematically illustrates acquiring an image of a hand in an idle state prior to performing a hand-motion gesture.

Camera 14 of food intake monitor device 10 is aimed such that field of view 50 of camera 14 partially covers back-of-hand region 54 of hand 90.

FIG. 9B schematically illustrates acquiring an image of a hand in an indicating state in which the hand is bent backward at the wrist.

Moved back-of-hand region 54′ of bent hand 90′ is imaged by camera 14. Moved back-of-hand region 54′ may completely fill field of view 50. The gesture as shown may be performed by an empty hand of the user (e.g., a hand that is not used for eating), when holding a utensil such as a glass, cup, knife, fork, spoon, or other utensil, or under other circumstances. The gesture as shown may be also performed by a hand of the user that is used for eating, when holding a utensil or food, or under other circumstances.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A device for monitoring food intake by a user to whom the device is attached, the device comprising:
at least one camera to acquire a series of images of at least a partial view of a manipulable limb of the user;
a processor configured to apply a probabilistic model to determine based on the series of images if a motion of the limb corresponds to at least one predetermined gesture that is indicative of taking a bite, and to update a recorded sequence of events when the motion is determined to correspond to said at least one predetermined gesture; and
a signaling unit that is operable by the processor to produce a signal that is sensible by the user, wherein the signal is indicative of the updating of the sequence of events.

2. The device of claim 1, wherein the signaling unit is operable to produce a haptic signal.

3. The device of claim 2, wherein the haptic signal comprises a vibration or knocking.

4. The device of claim 2 wherein the signaling unit is placed so as to contact the user's skin when the device is attached to the user.

5. The device of claim 1, wherein, the processor is further configured to adjust operation of the signaling unit in accordance with a confidence level that is determined by the application of the probabilistic model.

6. The device of claim 1, wherein the device further comprises a band for placement about the limb for attachment to the limb.

7. The device of claim 1, wherein said at least one camera comprises at least two cameras, such that the series of images comprises images of different sides of the limb.

8. The device of claim 1, wherein the device further includes an audio device or a display device.

9. The device of claim 1, wherein the manipulable limb comprises a finger or hand.

10. The device of claim 1, wherein the processor is further configured to compare a counted number of bites with a recommended number of bites, or a rate of counting of bites with a recommended rate of taking bites.

11. The device of claim 10, wherein the processor is further configured to operate the signaling unit to generate a signal in accordance with a result of the comparison.

12. The device of claim 1, wherein the application of the probabilistic model comprises:
identifying a feature in the acquired series of images;
comparing the identified feature with one or more gesture features that are retrieved from a database of gesture features; and
calculating a value that is indicative of a degree of correspondence between the identified feature and the gesture feature.

13. A method for monitoring food intake by a user, the method comprising:
acquiring using a camera that is attached to the user a series of images of a manipulable limb of the user;
analyzing the acquired images, using a processor, to identify a motion of the limb;
applying by the processor a probabilistic model to calculate a probability that the identified motion corresponds to at least one predetermined gesture that is indicative of taking a bite;
using the probability by the processor to determine if the identified motion is indicative of taking a bite during a time segment; and
when the identified motion is determined by the processor to be indicative of taking a bite, updating a sequence of events and generating a signal.

14. The method of claim 13, wherein the limb comprises a finger or hand.

15. The method of claim 13, further comprising generating a reminder signal.

16. The method of claim 13, wherein generating the signal comprises operating a haptic signaling unit to generate a haptic signal.

17. The method of claim 13, wherein generating the signal comprises adjusting the generating of the signal in accordance with a confidence level that is determined by the applying of the probabilistic model.

18. The method of claim 17, wherein adjusting the generating of the signal comprises decreasing a reinforcement level when application of the probabilistic model indicates an increase in the confidence level.

19. The method of claim 13, further comprising comparing the sequence of events with a recommended number of bites or with a recommended rate of taking bites, and generating a signal in accordance with a result of the comparison.

20. The method of claim 13, wherein the acquired images comprise a partial view of the limb.
